(19) United States
(12) Patent Application Publication
(10) Pub. No.: US 2009/0053490 A1
(43) Pub. Date: Feb. 26, 2009

(54) Highly Filled Composite Materials

(76) Inventors: Robert N. Clausi, Oakville (CA); Savaltore Diloreto, Ancaster (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/280,483

(22) PCT Filed: Feb. 16, 2007
(86) PCT No.: PCT/CA07/00255

§ 371 Date: Aug. 22, 2008

Related U.S. Application Data
(60) Provisional application No. 60/775,790, filed on Feb. 23, 2006.

(51) Int. Cl. B32B 5/22; C08J 9/35; B29C 44/02

(52) U.S. Cl. 428/213; 521/55; 428/219; 264/45.1

(57) ABSTRACT

The present invention is directed to a low to high density foamed or solid composite material that comprises a blend of an epoxy based resin system or a low or high molecular weight polyurethane-based pre-polymer resin system and a relatively high level of a broad range of reinforcing materials dispersed therein. The reinforcing materials may be recycled or virgin, organic or inorganic, materials in the form of particles, shavings, flakes, pellets, crystals, hollow or solid spheres, granules or fibers, and may vary in specific gravity and size. The resin system permits a substantially uniform dispersal of the reinforcing materials and subsequently cures to create a complex composite material matrix. The composite material may be rigid, semi-rigid or flexible. The present invention is also directed to a process for preparing the rigid, semi-rigid or flexible foam composite which can be subsequently molded, extruded, calendered or used in spray-applications. The foam composite material is useful in a variety of applications, and can be easily varied or modified to include a wide variety of coarse and fine multi-size reinforcing materials. Applications for the composite material include lightweight moisture resistant insulative building materials, automotive, transportation and aerospace components, filter materials, molded components, and the like.

### FIELD OF THE INVENTION

The present invention relates to the field of composite materials, and in particular, is directed to a rigid, semi-rigid, or flexible composite material comprising an epoxy based, or polyurethane based pre-polymer resin, combined with a variety of filler materials, which filler materials may be dispersed in the resin in order to form a highly filled foam or a highly filled composite material. The present invention is also directed to a method of preparing these rigid, semi-rigid or flexible foam or composite materials. Further, the present invention is also directed at products made using the process.

### BACKGROUND OF THE INVENTION

Chemicals and plastic raw materials that are byproducts from petroleum are increasing in cost. Even traditionally economical foamed materials, such as polyurethane foams are becoming more costly due to their reliance on these chemicals. Also affected are products made with heavy materials which products must be manufactured close to their markets due to high transportation costs.

This invention allows for the development and manufacture of new light-weight, high-performance epoxy and polyurethane based foam-composite materials that use a high degree of organic and inorganic fillers to achieve a variety of material characteristics. These materials can be rigid, semi-rigid or flexible. The materials can be processed with existing manufacturing equipment and tooling technology. Products made from epoxy and polyurethane based foam-composite materials can replace thermoplastic and thermo-set materials, textiles, metals, rubber, wood, stone, gypsum and cement-like materials, etc.

Many inventions relate to the use of fillers for polyurethane foam. Typically, fillers are utilized in small quantities to alter the properties of the foam or to reduce cost. It is well known that using fillers in the foaming process is very difficult in practice since filler particles are typically added to either the polyol side or the resin side, and do not foam well in high concentrations. Particles tend to collapse the cell walls during the foaming process and the resin cures with little or no cell expansion. However, prior attempts to introduce fillers have been marginally successful in resolving some of the processing problems.

For example, PCT Patent publication No. WO97/39043 to Mushovic discloses a polyester resin and a urethane resin combination which also uses styrene. The preferred filler cited is flyash which is used for its light weight. However, this system would require additional reinforcement particles for strength. The inventor also requires that the polyester resin and urethane resin combination must be free-radical initiated in order to work. Without the free-radical initiator, the foam and filler will not expand and cure uniformly. This patent, however, is limited to specific resin combinations, and does not teach the use of, for example, a 100% polyurethane pre-polymer resin or epoxy resin combined with a relatively high level of a variety of multi-size reinforcing particles from organic and inorganic materials in both fibrous and particulate form.

U.S. Pat. No. 5,508,315 to Mushovic discloses a polyester resin and urethane resin combination which also uses styrene. It is to be noted that in a pure polyurethane system, the inventor teaches that, if the growing cell structures of the foam cannot support all of the filler, the gasses will escape and the expanded resin will drop back to its original state and cure with little or no expansion. To address this problem, the inventor again describes that a two polymer system must be used.

U.S. Pat. No. 4,217,422 to Wasilczyk and U.S. Pat. No. 4,145,487 to Behme, each disclose a system wherein the filler content must be in a low concentration only. These patents do not teach the use of a 100% polyurethane pre-polymer or epoxy resin combined with a variety of multi-size reinforcing particles from organic and inorganic materials in both fibrous and particulate form at a high filler concentration.

U.S. Pat. No. 4,243,755 to Marx, U.S. Pat. No. 4,871,477 to Dimanshteyn, and U.S. Pat. No. 4,795,763 to Gluck, all disclose polyurethane foam systems that use 3 to 50% (preferably 5 to 20%) filler with a particle size of less than 7 microns. These patents do not teach, however, the use of, for example, a 100% polyurethane pre-polymer or epoxy resin combined with a variety of multi-size reinforcing particles chosen from organic and inorganic materials in both fibrous and particulate form at high filler concentrations.

U.S. Pat. No. 4,397,978 to McKinney et al. discloses a polyurethane foam specifically used as a fire suppressant polyurethane foam backing material for carpets for airplanes using 50 to 80% of an inorganic filler component by weight combined with a halogen-containing resin in a two part system. This patent does not teach the use of, for example, a 100% polyurethane pre-polymer or epoxy resin combined with a variety of multi-size reinforcing particles from organic and inorganic materials in both fibrous and particulate form at a high filler concentration.

Thus, while the prior art has provided a series of foamed materials which include filler materials, they have not provided foamed materials having a high filler level which can be maintained, or can be formulated to provide a wide variety of physical properties, while maintaining their high filler level.

### SUMMARY OF THE INVENTION

It is an object of this invention to provide a rigid or flexible foam composite material. In particular, it is an object of the present invention to provide a foamed composite material having a high filler level, and wherein, depending on the type of resin used, the foamed composite material can be modified to produce rigid, semi-rigid, or flexible materials.

It is a further object of this invention to provide composite foam materials using conventional and known manufacturing processes including compression molding, calendaring, extruding, or other forming methods. The foam composite may be formed into complex near net-shape or net-shape three-dimensional objects, solid and tubular extrusion profiles, panels, and other forms.

It is another object of this invention to provide a foam composite material which has a high filler level, but which is capable of reducing the overall weight of the resulting product.

It is another object of this invention to provide a highly filled rigid, semi-rigid or flexible foam composite material which will take on at least some of the characteristics of the filler material in order to improve the properties of the resulting product. It is therefore also an object of the present invention to provide a system wherein the flexibility of the resulting composite may be increased if the reinforcing material is also flexible.

It would therefore be advantageous to provide a foam composite material, and a method for producing the foam composite material, which would be able to meet any or all of the above objectives.

It has now been found that the advantages set out above, as well as other objects and goals inherent thereto, are at least partially or fully provided by the foam composite material and production process, of the present invention, as set out herein below.

Accordingly, in one aspect, the present invention provides a method for the production of a rigid, semi-rigid or flexible foam composite material comprising:

(i) providing a resin system component comprising either:
(a) a polyurethane pre-polymer prepared by reacting a poly or di-isocyanate resin, with a polyol material selected from the group consisting of:
1. a saturated polyether polyol;
2. an unsaturated polyether polyol;
3. a saturated polyester polyol;
4. an unsaturated polyester polyol;
5. a caprolactone polyol;
6. a butadiene polyol;
7. a castor oil-based polyol; or
8. mixtures thereof and therebetween of the above named polyol materials, in order to produce an at least partially cured polyurethane pre-polymer or:
(b) an epoxy resin pre-polymer prepared by reacting an epoxy resin with an appropriate hardening agent in order to prepare an at least partially cured epoxy resin;
(ii) blending said resin system component, in a blending stage, with a high level of organic or inorganic reinforcing materials to form a polymer mix; and
(iii) curing said polymer mix in a forming stage wherein in said forming stage, said polyurethane pre-polymer or said epoxy resin pre-polymer is optionally foamed to produce said composite or foam composite material.

The forming stage is preferably conducted under heat and/or pressure, and is preferably accomplished using:
1. an injection molding process;
2. an extrusion process;
3. a calendaring process;
4. a compression molding process;
5. a spray foam application process; or using
6. a slab stock foam process
7. a rotational molding process.

However, other conventional or non-conventional manufacturing processes might also be used for the forming stage.

The ratio of the resin system component, and more particularly, the polyurethane pre-polymer or epoxy resin component, to reinforcing material will vary, depending upon the specific gravity of the filler particles.

If the particles are voluminous with a low specific gravity such as hollow glass micro spheres, the ratio of pre-polymer resin to filler is preferably between 0.1 and 5 to 1 on a volume basis. More preferably, the ratio of pre-polymer resin to filler will be between 0.2 and 3 to 1, on a volume basis, and still more preferably, between 0.5 and 2 to 1, on a volume basis. In a preferred embodiment, the level of low specific gravity filler is at least 25%, and more preferably, at least half of the volume of the resin material. The resulting foam composite after forming is preferably up to 2 or more times the volume of the mixture prior to forming. For the purposes of this document, a low specific gravity particle is one having a bulk density of less than 0.32 g/cc.

If the particles have a higher specific gravity, namely one which is equal to or greater than 0.32 g/cc such as ceramic powder, the ratio of pre-polymer resin to filler is preferably between 0.1 and 2.5 times the amount of the pre-polymer resin by weight. More preferably, the ratio of pre-polymer resin to filler is between 0.2 and 2 to 1, on a weight basis, and still more preferably, between 0.5 and 1.5 to 1, on a weight basis. In a preferred embodiment, the level of high specific gravity filler is at least 25%, and more preferably at least half, the weight of the resin material.

The resulting composite after forming is preferably at least slightly higher than the volume than the volume of the mixture prior to forming.

Once the foam composite part is fully formed and cured, the final density may have a range of between 0.032 grams/cc (2 lb/cu ft) to 1.60 grams/cc (100 lbs/cu ft). Preferred density will be in the range of between 0.16 grams/cc (10 lb/cu ft) to 0.80 grams/cc (50 lb/cu ft). Final density for the cured foam composite part will depend upon: (i) the amount of mixed material introduced into the mold or die; (ii) the bulk density of the filler particles, and; (iii) the amount of resin required to produce a foamed composite part that has acceptable mechanical and physical properties.

The exact ratio of filler to pre-polymer resin to final molded article will require adjustment by someone skilled in the art depending upon the final material properties required for a particular application.

The ratio of polyurethane or epoxy resin to polyol is typical identical to the ratios normally used in the prior art to cure these types of polymer systems. Preferably, however, the amount of resin in this mixture is in the amount of from 1 to 40%, and more preferably in the ratio of from 2 to 30%. The skilled artisan will be aware that these ranges will vary, however, depending on the resins selected, and on the desired properties of the polymer system. In a further aspect, the present invention also provides a foam composite material, which material has been produced by the method as described hereinabove. In a still further aspect, the present invention also provides an uncured mixture of the said resin system component and said reinforcing materials, preferably in a powdered form.

### DETAILED DESCRIPTION OF THE PREFERRED EMBODIMENTS

In the present application, the term “foamed composite material” refers to a specific material produced according to the process described herein. While the present discussion describes the production of foam composite materials in general, the skilled artisan will be aware that these materials can be used in a wide variety of applications.

The present invention adopts an approach to composite polymer materials that is completely different from that described hereinabove with respect to the prior art, by requiring the use of the selected resin system components, including the polyurethane pre-polymer resin, or the epoxy resin, as will be described in detail, hereinbelow. While not being bound by theory, it is believed that the increased surface tension energy of the selected resin system allows for heavy and irregularly shaped particles and fibers to be uniformly dispersed throughout the pre-polymer resin matrix. High concentrations of the filler or reinforcing particles can therefore be used to dramatically improve the properties of the pre-polymer resin reinforcing fiber matrix.

The following diagram describes the reaction of a process to prepare a typical polyurethane pre-polymer resin:

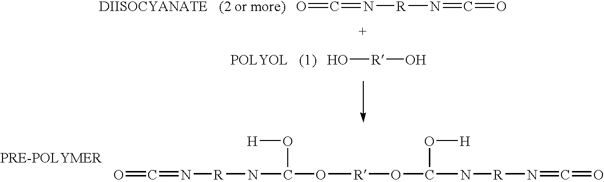

where R and R′ are used to designate any of a variety of suitable alkyl or aromatic groups.

Depending upon the type of foam composite structure that is required by a specific application, the resin system may have a low molecular weight which promotes the formation of a rigid composite material. To achieve a semi-rigid composite material a medium molecular weight resin system is typically used. To achieve a flexible foam composite, a high molecular weight resin system would preferably be used. As such, the desired hardness and strength of the resin system can be, to a large extent, controlled by selection of a resin having an appropriate molecular weight.

With respect to the polyurethane-based resin systems, low molecular weight pre-polymer resin preferably contain from 20 to 30% isocyanate content. Medium molecular weight pre-polymer resin preferably contain from 12 to 20% isocyanate content. High molecular weight pre-polymer resin preferably contain from 2 to 12% isocyanate content. All percentage values are by weight unless otherwise stated.

The polyol portion of the polyurethane pre-polymers can be any suitable polyol commonly used within the art, and can include aliphatic or aromatic polyols, including polyester, polyether, and caprolactone-based polyols. The polyols include materials such as glycerol, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5,1,2,6-hexanetriol, 1,1,1-trimethylolpropane, or the like, or can be made by any suitable production method which would typically and preferably involve reacting ethylene oxide (EO), propylene oxide (PO) or butylene oxide (BO) with materials such as: 1,1,1-tris[(2-hydroxyethoxy)methyl]ethane, 1,1,1-tris-[(2-hydroxypropoxy)methyl]propane, triethanolamine, triisopropanolamine, pyrogallol or phloroglucinol, in order to form a chain-extended polyol.

One example of a suitable chain-extended polyol is the polyether triol sold under the trade name XD 1421, which is made by the Dow Chemical Company. It has a molecular weight of around 4900, and is composed of a ratio of three oxyethylene (ethylene oxide) units randomly copolymerized per one unit of oxypropylene (propylene oxide). It has a hydroxy content of 0.61 meq. OH/g. Another example of a material which is commercially available is Pluracol.® V-7 made by BASF Wyandotte which is a high molecular weight liquid polyoxyalkylene polyol. Other polyols which might be used at polyether polyols such as Pluracol 492 from BASF, having a molecular weight of 2000. Alternatively, saturated polyester polyols such as Desmophen 2500 from Bayer, having a molecular weight of 1000 might be used. Further, castor oils such as DB caster oil or regular commercial grades of castor oil available from for example, CAS Chem, might also be used. Additionally, polybutadiene resins, such as Poly BD R45T, available from Sartomer, can be used. However, a wide variety of polyols might be used. Further, combinations of various polyols, or types of polyols might also be used.

The preferably chain extended polyol is capped with a polyisocyanate to form the pre-polymer. The isocyanate component of the polyisocyanate preferably has a functionality of 2.0 or more, and more preferably, a functionality of between 2.0 and 3.0, and can include diisocyanates and polyisocyanates of the aliphatic, alicyclic, or aromatic types. The amount and type of isocyanate monomer used, or used in the production of the isocyanate component will directly affect the level of isocyanate groups present. For example, hexamethylene diisocyante (HDI), has a monomeric level of isocyanate of 50% NCO. Other materials will have different monomeric NCO levels, such as, for example, Bis-(4-Isocyanatocyclohexyl)methanes (H12MDI) at 31.8% NCO; isophorone diisocyanate (IPDI) at 37.5% NCO; toluene diisocyanate (TDI) at 48% NCO; or methyl diphenyl diisocyanate (MDI) at 28-34% NCO. When reacted to form the isocyanate prepolymer component, the monomeric NCO level will affect the isocyanate level of the resulting prepolymer material.

The isocyanate is preferably a isocyanate selected from MDI, TDI, hexamethylene diisocyanate (HMDI), HDI, IPDI, TMXDI (1,3-bis-isocyanato-1-methylene ethylene benzene), or any of their oligomers, pre-polymers, dimers, trimers, allophanates and uretidiones.

Further, suitable polyisocyanates useful in preparing the pre-polymer include, but are not limited to, toluene-2,4-diisocyanate, toluene-2,6-diisocyanate commercial mixtures of toluene-2,4- and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 3,3′-diphenyl-4,4′-biphenylene diisocyanate, 4,4′-biphenylene diisocyanate, 3,3′-dichloro-4,4′-biphenylene diisocyanate, 1,6-hexamethylene diisocyanate, 1,4-tetramethylene diisocyanate, 1,10-decamethylene diisocyanate, 1,5-naphthalenediisocyanate, cumene-2,4-diisocyanate, 4-methoxy-1,3-phenylenediisocyanate, 4-chloro-1,3-phenylenediisocyanate, 4-bromo-1,3-phenylenediisocyanate, 4-ethoxy-1,3-phenylenediisocyanate, 2,4′-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediisocyanate, 9,10-anthracenediisocyanate, 4,4′-diisocyanatodibenzyl, 3,3′-dimethyl-4,4′-diisocyanatodiphenylmethane, 2,6-dimethyl-4,4-diisocyanatodiphenyl, 2,4-diisocyanatostilbene, 3,3′-dimethyl-4,4′-diisocyanatodiphenyl, 3,3′-dimethoxy-4,4′-diisocyanatodiphenyl, 4,4′-methylene bis(diphenylisocyanate), 4,4′-methylene bis(dicyclohexylisocyanate), isophorone diisocyanate, PAPI (a polymeric diphenylmethane diisocyanate, or polyaryl polyisocyanate), 1,4-anthracenediisocyanate, 2,5-fluorenediisocyanate, 1,8-naphthalenediisocyanate and 2,6-diisocyanatobenzfuran.

Also suitable are aliphatic polyisocyanates such as the triisocyanate Desmodur N-100 sold by Bayer which is a biuret adduct of hexamethylenediisocyanate; the diisocyanate Hylene W sold by du Pont, which is 4,4′-dicyclohexylmethane diisocyanate; the diisocyanate IPDI (Isophorone Diisocyanate sold by Thorson Chemical Corp.), which is 3-isocyanatomethyl-3,5,5-trimethylcyclohexyl isocyanate; or the diisocyanate THMDI sold by Verba-Chemie, which is a mixture of 2,2,4- and 2,4,4-isomers of trimethyl hexamethylene diisocyanate.

Further examples of suitable isocyanate components include 2,4-tolylenediisocyanate, 2,6-tolylenediisocyanate, 4,4′-diphenylmethanediisocyanate, 4,4′-diphenylthere-diisocyanate, m-phenylenediisocyanate, 1,5-naphthalene-diisocyanate, biphenylenediisocyanate, 3,3′-dimethyl-4,4′-biphenylenediisocyanate, dicyclohexylmethane-4,4′diisocyanate, p-xylylenediisocyanate, bis(4-isocyanatophynyl)sulfone, isopropylidene bis(4-phenylisocyanate), tetramethylene diisocyanate, isophorone diisocyanate, ethylene diisocyanate, trimethylene, propylene-1,2-diisocyanate, ethylidene diisocyanate, cyclopentylene-1,3-diisocyanates, 1,2-, 1,3- or 1,4-cyclohexylene diisocyanates, 1,3- or 1,4-phenylene diisocyanates, polymethylene ployphenylleisocyanates, bis(4-isocyanatophenyl)methane, 4,4′-diphenylpropane diisocyanates, bis(2-isocyanatoethyl) carbonate, 1-methyl-2,4-diisocyanatocycloheane, chlorophenylene diisocyanates, triphenylmethane-4,4′4″-triisocyanate, isopropyl benzene-a-4-diisocyanate, 5,6-diisocnanatobutylbicyclo[2.2.1]hept-2ene, hexahydrotolylene diisocyanate, 1-methoxyphenyl-2,4-diisocyanate, 4,4′4″-triphenylmethane triisocyanate, polymethylene polyohenylisocyanate, tolylene-2,4,6-triisocyanate, 4,4′-dimethyldiphenylmethane-2,2′5,5′-tetraisocyanate, and mixtures thereof.

For the production of epoxy foam composites, either aromatic or aliphatic resin systems, preferably based on Bisphenol A to F and Novolac resins, which have been reacted with epichlorohydrin, may be used. These may be used in combination with, for example, amine hardeners, but may be used with any suitable hardeners including aliphatic, alicyclic, aromatic, imido, amide or amine containing materials, and blends thereof.

The epoxy systems may also be modified with amine terminated polyols to produce less rigid foam composites.

The epoxy resin preferably has an epoxide equivalent weight of between 140 and 650, and is preferably reacted with an amine hardener having an amine equivalent weight of between 15 and 400.

Reinforcing materials to produce epoxy foam composites must include hardwood or softwood fiber in a variety of particle sizes ranging from fine wood flour (above 100 mesh) to coarse wood fibers (below 80 mesh). It is presumed that an agent naturally occurring in the wood fiber reacts to liberate gases thus creating a foam matrix. The final product typically exhibits a cellular core and tough surface skin accurately reproducing my detail in the mold tooling. Due to the reacted fiber matrix, the resulting product is highly chemical and moisture-resistant and does not display the brittle tendencies of solid unfilled epoxy materials.

A wood fiber filler is used in combination with the epoxy resin system. However, it is to be noted that the present invention allows for the use of, or the additional use of, a broad range of reinforcing materials. The term “reinforcing materials” as used herein is intended to encompass a broad range of filler materials, which can be used in the production of a wide range of forms. A variety of particle sizes, shapes and densities of filler materials can be used, as well as combinations of various types of reinforcing agents.

The filler is mixed with the pre-polymer system in order to typically produce a high viscosity product which is capable of maintaining the suspension of the filler in place, while the material is being foamed, or otherwise, being cured.

The dispersed filler particles which form the reinforcing agent are preferably at least partially chemically or physically bonded to the polymer matrix, although this is not required. This bonding can occur on the surface of the filler material, which may be the physical surface, or may extend to some depth below the surface at which depth the bonding and the filler materials are capable of bonding.

The reinforcing materials may be organic or inorganic in nature. Examples of suitable materials for the reinforcing material include rubber, glass, sand, crystalline powders, ceramic materials, milled carbon fiber, chopped glass, steel, synthetic particles or fibers, milled fibers, aramid based fibers, finely ground rubber, hollow or solid spheres, hollow glass spheres, solid glass spheres, natural fibres, protolignin-containing natural fibers such as wood flour, Portland cement, copper particles, aluminum particles, recycled thermoset materials, recycled plastic granules, thermoplastic granules, and mixtures thereof.

The reinforcing materials may also be supplemented by mineral fillers, wood flour, milled carbon fiber, milled aramid fiber, directional and non-direction structural fabrics, metallic plates, wood veneer, paper or the like, and mixtures thereof.

The reinforcing materials may also include any mixture or combination of the above named materials.

Preferably, the filler particles may range in size between 50 to 5,000 microns in diameter (including a combination of sizes). More preferably, the filler particle size range will vary between 100 to 1000 microns. There may also be a mixture of the sized particles in a typical composition.

The particles may also be in a range of shapes including regular and irregularly shaped crystals, regular and irregularly shaped fibers, regular and irregularly shaped spheres, regular and irregularly shaped granules, regular and irregularly shaped shavings, and other shapes.

In some cases, the reinforcing material is preferably treated to enhance surface bonding between the filler material and the pre-polymer matrix. The surface may thus be modified by the addition of known surface modifiers, such as silane, or polymer emulsion coatings.

Specifically, some reinforcing particles such as hollow glass spheres may be pre-coated with silane promoting a better chemical bond between the matrix resin and the particle. Hollow glass spheres also have a higher surface area than similarly-sized spherical particles thus providing for improved mechanical bonds.

Lightweight and voluminous reinforcing materials such as hollow glass spheres will typically represent a lower weight than the resin in a typical mixture. Reinforcing materials that have a high specific gravity such as crushed quartz will represent a higher weight than the resin in a typical mixture. The final composition will depend upon the desired end properties of the composite foam for a particular application.

Generally, the formed composite material will have the basic properties of the reinforcing material. For example, foam composite materials made with rubber particles will tend to have a flexible rubber surface comprising the particles chemically bonded in the pre-polymer resin matrix. It is also noted that certain materials, such as quartz particles in a variety of sizes can be used to make a foamed composite that is hard, lightweight and fire-resistant at a low cost. As such, the reinforcing material can be selected to provide a foam composite material that is inherently fire resistant.

The resultant composite foam material product can have a constant or variable density across a cross-section of the product. Commonly, the density of the product is typically higher at the outer surface, and generally decreases towards the centre core of the product. Alternatively, the product can appear essentially solid and/or have a foam structure wherein the foam voids are barely visible.

Preferably, the filler particles may range in size between 50 to 5,000 microns in diameter (including a combination of sizes). More preferably, the filler particle size range will vary between 100 to 1000 microns. There may also be a mixture of the sized particles in a typical composition.

The particles may also be in a range of shapes including regular and irregularly shaped crystals, regular and irregularly shaped fibers, regular and irregularly shaped spheres, regular and irregularly shaped granules, regular and irregularly shaped shavings, and other shapes.

When used, the catalyst added to the system can be amine based, including, for example, primary, secondary or tertiary amines or combinations thereof. The catalysts can also be metallic based, including, for example, tin, lead, bismuth based catalysts, or the like. Catalysts can be used which promote the formation of urethane linkages in the polyurethane based systems, by reaction of isocyanate groups and hydroxyl groups. These types of amine catalysts include, for example, triethylenediamine, N-methylmorpholine, tetramethyl-2,4-butanediamine, N-methylpiperazine, dimethylthanolamine, triethylamine, and the like; and organometallic compounds, such as stannous octanoate, dibutyltin dilaurate, dibutyltin di-2-ethylhexanoate, and the like. The catalysts may be used alone or in combination with one another. The amount of catalyst typically used is a broad range of amounts, which usually ranges from 0.03 to 2.0 parts by weight, and preferably between 0.02 to 1.2 parts by weight based on the total weight of the composition, exclusive of the reinforcing materials.

Surfactants might also be added. By introducing surfactants, the foam composite materials can be made as closed cell and open cell depending upon the desired application. Where uniformity of cell structure is required, fine organic or inorganic particles may be used in a size range between 50 and 500 microns. Where random cell structure is acceptable, larger reinforcing particles may be used. Surfactants, when used, are preferably silicone based, although any suitable surfactant might be used.

Other materials can be included in the formulations of the present invention. For example, coupling agents, such as silane or titanates, may also be included in the preparation of the composition to improve the physical properties of the material by binding the resin, and in particular, the urethane pre-polymer resin more efficiently to the reinforcing materials.

Where other properties are desired additives may be added to the composition including colorants, dry or liquid inks or pigments, fire and flame retardants, internal mold release additives, antistatic agents, and such other additives as required.

The mixing of the composition requires an efficient shear mixer to homogeneously blend the reinforcing materials with the pre-polymer resin, surfactants, catalyst, blowing agent, colorants and other additives as required to make the composition material. Preferably, after the high shear mixing stage, and depending upon the filler used, the resultant polymer mix may be in the form of a dry powder, a moist powder, a viscous liquid or a mastic. Preferably, the resultant polymer mix is an essentially or substantially dry powder having a high filler content. The consistency of the blended material will however, to a large extent, depend on the resin absorption properties of the filler component.

The composition material is introduced into a mold cavity, or extruded through a die, calendered, sprayed on a surface, or used in some other processing method, and is caused to react. The composition may be pumped, blown, sprayed, or poured into the mold cavity, depending on the physical nature of the pre-polymer mixture. To improve the processing speed the forming tool may be heated thereby promoting a faster reaction.

Those skilled in the art will be aware that tooling should preferably allow excess gasses to exit so as to allow the composition to expand to the tool surface thus providing for a uniform, surface that is preferably smooth and free of pitting.

Prior to introducing the composition material into the forming tool, a release agent or coating in the form of a gel-coat system can be applied to the surface of the tool. The release agent or in-mold coating may comprise acrylic, urethane, melamine vinyl, silicone, epoxy, polyester coatings and combinations thereof to achieve the desired appearance and surface features.

Surface features such as a variety of textures may be applied to the tool surface to be molded into the final composite product.

The composition in the mold may then be foamed, as part of the curing reaction, to form a foam composite material. The final product will have a foamed, or a non-foamed core with a uniform decorative surface coating. In some systems, the foamed nature will be clearly evident, but in others, such as a highly filled composite material, the core of the product may appear semi-solid, or slightly porous rather than appearing as a foam.

The foaming process can occur when, for example in the polyisocyanate system, the isocyanate from the blended pre-polymer resin reacts with moisture (water) in or on the surface of the reinforcing materials which causes carbon dioxide gas to be liberated. Nucleation of the foam encompasses the reinforcing material and expands the composition causing the reinforcing material to be distributed uniformly.

Alternatively, water can be added to the reaction system, or some other blowing agent can be added to generate a gaseous material during the curing reaction.

Preferably, the composite material is produced so that it provides a foam composite material that once formed, fully cured and crosslinked, does not off gas. Those skilled in the art would be aware of techniques to achieve this state.

Natural fibers such as hardwood fibers tend to have multiple advantages as a reinforcing material. It is believed that they also tend to absorb the pre-polymer resin during the mixing stage and during the forming stage; the fibers tend to release the resin as the expanding foam composite reaches the walls of the forming tool. This reaction also benefits from the natural moisture present within the wood fibers. This moisture acts as a built-in blowing agent thereby increasing energy available from the pre-polymer resin. The irregular shape and larger surface area of the natural fiber also provides for improved mechanical bond. Natural fibers also tend to have high overall physical properties in terms of tension, torsion and compression strength. The present invention works with a broad range of natural fibers.

In particular, in the epoxy based system, using “dry” (approx 5 to 7% moisture) natural fibers (35% of the total batch weight) and epoxy resin (65% of the total batch weight) creates a foamed epoxy natural fiber composite that is moisture proof, stable, thermally stable, UV resistant, chemical resistant, lightweight and strong. It is believed that the epoxy resin is attracted to the hydroxyl groups naturally present in the natural fibers. The resulting foam has a vast range of applications including building products and automotive components. The epoxy-based resin may be formulated for a specific application as a rigid or flexible composite.

The foam composite materials of the present invention can be custom formulated for better material properties. As such, the resulting polyurethane or epoxy foam composite materials provide an ease of processing while providing numerous advantages in many important industries.

As a result of foaming, the density of the resultant foam composite material is reduced. Preferably, the foam composite material has an average density of at least 2 lbs/ft³ (0.032 g/cm³) to 100 lbs/ft³ (1.60 g/cm³). Thus, the foamed composite materials of the present invention typically have reduced weight, when compared to other systems having less fillers and/or more resin. Further, foamed composite components made with natural fibers may be used to provide strong, lightweight, and energy-absorbing components for automobiles and other transportation vehicles thereby requiring less energy to operate.

The foamed composite material might also be produced so as to be electrically conductive, by using reinforcing particles made from various materials that are organic such as graphite, and carbon black, or that are metallic such as aluminum oxide or copper sulfate.

The foam composite material might also be produced by foaming the composition between an upper and lower reinforcing fabric such as paper, carbon fiber, fiberglass, or aramid fiber cloth. To improve the adherence between the expanded foam composite and the textile material may be pre-treated with a silane. The resulting composite product will have a rigid but lightweight sandwich construction able to transfer a load through the core combined with other properties such as low sound transmission.

The foam composite material might also be produced in a system which is under a compressive pressure. Under these conditions, compression pressures of 0 to 1,000 psi (0 to 70.30 kg/cm²) can be applied.

The composite foam material of the present invention can also be custom formulated and engineered for specific applications. The range of formulations includes using rigid, semi-rigid, or flexible polyurethane pre-polymer with a range of organic and inorganic reinforcing materials which may be in the form of a particle or fiber with the said reinforcing materials being in a variety of densities, sizes and regular and irregular shapes.

The ability to use a wide range of reinforcing filler materials might also allow for the production of foam composite materials which utilize large quantities of recycled reinforcing filler materials. As such, the present invention allows for the production of a material which is environmentally responsible in that it uses relatively minimal amounts of energy in the manufacturing process, allows for the use of recycled materials, and the resultant foam composite product is relatively lightweight in nature which can reduce the amount of fuel used, and thus the transportation cost, to move the final product.

It is also to be noted that the particulate or fiber reinforcing materials can be made from recycled or virgin raw materials. In fact, after use, the foam composite material may itself be ground up and recycled to produce additional material.

The finished product may be in the form of a foam composite when the multi-size reinforcing particles are dispersed by adding a blowing agent to uniformly distribute the reinforcing particles. A chemical blowing agent such as nitrogen, pentane, carbon dioxide, etc., may also be used directly or released in a reaction to form a foam and/or disperse the reinforcing particles.

If the desired composite material is not required to be a foam (but is merely a solid, semi-solid, or visually, a non-foamed material), a blowing agent may be omitted from the mixing step prior to the forming step.

The products of the present invention are typically suitable for thin wall, thick wall, and variable density forms (flat or three-dimensional), which can range from rigid to flexible depending on the resin system and filler selected. The products may have a variety of applications and can be used for plastics, concrete, metal, wood and synthetic rubber replacement applications and related uses The products may be developed and engineered for use as building materials such as dimensional lumber, siding, flooring roofing materials, as architectural products such as panels, and molding profiles, furniture panels, as countertops, as window profiles, as molded door panels, as outdoor products, as insulative panels, as fencing materials, as buoyant and corrosion-resistant marine products or coatings, as automotive components, as structural materials, as gasket material, as vibration isolation materials, as circuit board materials, as molded or extruded shelving materials, as speaker enclosures, as panels, as materials for the military where sound transmission and radar absorbing or non absorbing materials, as high strength foamed compositions for ballistic applications, as flexible covering materials, as high temperature insulative materials, as decorative or structural profiles, as malleable materials, as spray-applied foamed coatings, and other products as formed products wherein the composition material is formed in a mold or by other conventional and non-conventional manufacturing methods. A variety of other applications will be apparent to those skilled in the art.

Typically, and in a preferred embodiment, the foamed composite materials of the present invention form a natural “sandwich” type of material with a thick, higher density outer layer and a lower density cellular inner core. This ability to create a variable density structure by incorporating low-cost filler material offers significant structural and economic benefits. The resultant foam composite materials may have a combination of microcellular thin wall sections, and open cell core sections. Alternatively, the solid composite materials may be non-porous and have a uniform density.

The present invention also allows for the use of a variety of reinforcing materials in particle and fiber form to act as reinforcing material when dispersed in the polyurethane pre-polymer resin and other ingredients to produce a variety of value-added products.

### EXAMPLES

The following non-limiting examples indicate how to prepare composite materials according to the present invention and also provide a methodology for determining the optimal combinations of dispersed filler particle and polyurethane pre-polymer or epoxy resins, using only the disclosure in the specification and routine experimentation.

### Example 1

In the mixer vessel, 40 grams of rubber particles obtained by cryogenically freezing and grinding recycled rubber tires sized 30 mesh (1.1 grams/cc bulk density) are combined with 25 grams of rigid pre-polymer (16% NCO) with 0.4 grams of silicone surfactant (Air Products DC-193), 0.1 grams of tin catalyst (dibutyl tin dilaurate), 0.4 grams of water. The ingredients are mixed for 15 seconds in a lab blender with a whisk attachment at 50 rpm. The resultant moist powder is placed in a heated two-part clamshell mold and allowed to cure for 30 seconds at 160 degrees Celsius. A solid molded part with a final volume of 68.15 cc is released from the mold. The part has a variable density with thicker outer walls and with cellular voids in the core area. The molded part is flexible.

### Example 2

In the mixer vessel, 40 grams of rubber particles obtained by cryogenically freezing and grinding recycled rubber sized 30 mesh (1.1 grams/cc bulk density) are combined with 25 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant moist powder is placed in a heated two-part clamshell mold and allowed to cure for 30 seconds at 160 degrees Celsius. A solid molded part with a final volume of 68.15 cc is released from the mold. The part is variable in density with thicker outer walls and with cellular voids in the core area. The molded part is rigid except for the outer surface which is soft due to the rubber particles.

### Example 3

In the mixer vessel, 8 grams of K17 hollow glass spheres sized 200 mesh (0.18 grams/cc bulk density) are combined with 25 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable in density with thicker outer walls and with cellular voids in the core area. The molded part is flexible.

### Example 4

In the mixer vessel, 8 grams of calcium carbonate sized 120 mesh (2.3 grams/cc bulk density) are combined with 25 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant moist powder is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 5

In the mixer vessel, 40 grams of silica powder sized 400 mesh (0.8 grams/cc bulk density) are combined with 30 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable in density with thicker outer walls and with cellular voids in the core area. The molded part is flexible.

### Example 6

In the mixer vessel, 40 grams of silica powder sized 120 mesh (2.3 grams/cc bulk density) are combined with 25 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 7

In the mixer vessel, 8 grams of aluminum silicate sized 200 mesh (0.8 grams/cc bulk density) are combined with 20 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is flexible.

### Example 8

In the mixer vessel, 8 grams of aluminum silicate sized 200 mesh (0.8 grams/cc bulk density) are combined with 20 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 9

In the mixer vessel 40 grams of ceramic powder sized 400 mesh (2.4 grams/cc bulk density) are combined with 15 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius A solid molded part with a final volume of 68.15 cc is released from the mold. The part is variable density with thicker outer walls and with cellular voids in the core area. The molded part is flexible.

### Example 10

In the mixer vessel 40 grams of ceramic powder sized 400 mesh (2.4 grams/cc bulk density) are combined with 15 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 11

In the mixer vessel 70 grams of playground sand sized 80 mesh (2.5 grams/cc bulk density) are combined with 40 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is flexible.

### Example 12

In the mixer vessel 70 grams of playground sand sized 80 mesh (2.5 grams/cc bulk density) are combined with 40 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 13

In the mixer vessel 25 grams of graphite powder sized 300 mesh (0.9 grams/cc bulk density) are combined with 25 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius A solid molded part with a final volume of 68.15 cc is released from the mold. The part is variable density with thicker outer walls and with cellular voids in the core area. The molded part is flexible.

### Example 14

in the mixer vessel 25 grams of graphite powder sized 300 mesh (0.9 grams/cc bulk density) are combined with 25 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 15

In the mixer vessel 100 grams of Portland cement powder sized 200 mesh (2.2 grams/cc bulk density) are combined with 25 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part is released from the mold. The part is variable density with thicker outer walls and with cellular voids in the core area. The molded part is flexible initially becoming rigid after 48 hours.

### Example 16

In the mixer vessel 100 grams of Portland cement powder sized 200 mesh (2.2 grams/cc bulk density) are combined with 25 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius A solid molded part with a final volume of 68.15 cc is released from the mold. The part is variable density with thicker outer walls and with cellular voids in the core area. The molded part is rigid initially becoming harder after 48 hours.

### Example 17

In the mixer vessel 40 grams of hardwood flour sized 120 mesh (0.4 grams/cc bulk density) are combined with 25 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is flexible.

### Example 18

In the mixer vessel 40 grams of hardwood flour sized 120 mesh (0.4 grams/cc bulk density) are combined with 25 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 19

In the mixer vessel 40 grams of hardwood flour sized 60 mesh (0.4 grams/cc bulk density) are combined with 25 grams of flexible pre-polymer (10% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is flexible.

### Example 20

In the mixer vessel 40 grams of hardwood flour sized 60 mesh (0.4 grams/cc bulk density) are combined with 25 grams of rigid pre-polymer (16% NCO) with 0.4 grams of silicone surfactant, 0.1 grams of tin catalyst, 0.4 grams of water. The ingredients are mixed for 15 seconds in a lab blender with a whisk attachment at 50 rpm. The resultant mixture is placed in a heated two-part clamshell mold and allowed to cure for 30 seconds at 160 degrees Celsius. A solid molded part with a final volume of 68.15 cc is released from the mold. The part is variable density with thicker outer walls and with cellular voids in the core area. The molded part is rigid.

### Example 21

In the mixer vessel 35 grams of hardwood flour sized 60 mesh (0.4 grams/cc bulk density) are combined with 70 grams of epoxy resin prepolymer (Shell's Epon 826) comprised of 48 grams of resin with 22 grams of amine hardener. The ingredients are mixed for 15 seconds in a lab blender with a whisk attachment at 50 rpm. The resultant mixture is placed in a heated or room-temperature two-part clamshell mold. After approximately 2 to 3 minutes, the epoxy and wood mixture undergoes an exothermic reaction and begins to expand and foam. A solid molded part with a final volume of 68.15 cc is released from the mold. The part is variable density with thicker wood-filled epoxy outer walls and with wood-filled epoxy cellular voids in the core area. The molded part is rigid.

### Example 22

In the mixer vessel 35 grams of softwood flour sized 60 mesh (0.4 grams/cc bulk density) are combined with 70 grams of epoxy resin comprised of 48 grams of resin (A) with 22 grams of hardener (B). The ingredients are mixed for 15 seconds in a lab blender with a whisk attachment at 50 rpm. The resultant mixture is placed in a heated or room-temperature two-part clamshell mold. After approximately 2 to 3 minutes, the epoxy and wood mixture undergoes an exothermic reaction and begins to expand and foam. A solid molded part with a final volume of 68.15 cc is released from the mold. The part is variable density with thicker wood-filled epoxy outer walls and with wood-filled epoxy cellular voids in the core area. The molded part is rigid.

Thus, it is apparent that there has been provided, in accordance with the present invention, a foam composite material, and a method of production of the foam composite material, which fully satisfies the goals, objectives, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Also, while this discussion has addressed prior art known to the inventor, it is not an admission that all art discussed is citable against the present application.

1. A method for the production of a rigid, semi-rigid or flexible foam composite material comprising:
(i) providing a resin system component comprising either:
(a) a polyurethane pre-polymer prepared by reacting a poly or di-isocyanate resin, with a polyol material selected from the group consisting of:
1. a saturated polyether polyol;
2. an unsaturated polyether polyol;
3. a saturated polyester polyol;
4. an unsaturated polyester polyol;
5. a caprolactone polyol;
6. a butadiene polyol;
7. a castor oil-based polyol; or
8. mixtures thereof and therebetween of the above named polyol materials, in order to produce an at least partially cured polyurethane pre-polymer, or:
(b) an epoxy resin pre-polymer prepared by reacting an epoxy resin with an appropriate hardening agent in order to prepare an at least partially cured epoxy resin;
(ii) blending said resin system component, in a blending stage, with a high level of organic or inorganic reinforcing materials to form a polymer mix; and
(iii) curing said polymer mix in a forming stage wherein in said forming stage, said polyurethane pre-polymer or said epoxy resin pre-polymer is optionally foamed to produce said composite or foam composite material.

2. A method as claimed in claim 1 wherein said polyurethane pre-polymer comprises an isocyanate component which is an aliphatic, alicyclic, or aromatic diisocyanate or polyisocyanate.

3. A method as claimed in claim 2 wherein said isocyanate component has a functionality of between 2.0 and 3.0.

4. A method as claimed in claim 2 wherein said isocyanate component is selected from the group consisting of methyl diphenyl diisocyanate (MDI), toluene diisocyanate (TDI), hexamethylene diisocyanate (HMDI), hexamethylene diisocyante (HDI), isophorone diisocyanate (IPDI), TMXDI (1,3-bis-isocyanato-1-methylene ethylene benzene), and any of their oligomers, prepolymers, dimmers, trimers, allophanates and uretidiones.

5. A method as claimed in claim 2 wherein said isocyanate component is selected from the group consisting of toluene-2,4-diisocyanate, toluene-2,6-diisocyanate, commercial mixtures of toluene-2,4- and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 3,3′-diphenyl-4,4′-biphenylene diisocyanate, 4,4′-biphenylene diisocyanate, 3,3′-dichloro-4,4′-biphenylene diisocyanate, 1,6-hexamethylene diisocyanate, 1,4-tetramethylene diisocyanate, 1,10-decamethylene diisocyanate, 1,5-naphthalenediisocyanate, cumene-2,4-diisocyanate, 4-methoxy-1,3-phenylenediisocyanate, 4-chloro-1,3-phenylenediisocyanate, 4-bromo-1,3-phenylenediisocyanate, 4-ethoxy-1,3-phenylenediisocyanate, 2,4′-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediisocyanate, 9,10-anthracenediisocyanate, 4,4′-diisocyanatodibenzyl, 3,3′-dimethyl-4,4′-diisocyanatodiphenylmethane, 2,6-dimethyl-4,4-diisocyanatodiphenyl, 2,4-diisocyanatostilbene, 3,3′-dimethyl-4,4′-diisocyanatodiphenyl, 3,3′-dimethoxy-4,4′-diisocyanatodiphenyl, 4,4′-methylene bis(diphenylisocyanate), 4,4′-methylene bis(dicyclohexylisocyanate), isophorone diisocyanate, PAPI (Polymeric diphenylmethane diisocyanate), 1,4-anthracenediisocyanate, 2,5-fluorenediisocyanate, 1,8-naphthalenediisocyanate, and 2,6-diisocyanatobenzfuran.

6. A method as claimed in claim 2 wherein said polyurethane pre-polymer comprises a polyester, polyether, or caprolactone-based polyol.

7. A method as claimed in claim 2 wherein said polyurethane pre-polymer comprises a polyol component which is selected from the group consisting of glycerol, 3-(2-hydroxyethoxy)-1,2-propanediol, 3-(2-hydroxypropoxy)-1,2-propanediol, 2,4-dimethyl-2-(2-hydroxyethoxy)methylpentanediol-1, 5 or 1,2,6-hexanetriol, 1,1,1-trimethylolpropane or is made by reacting ethylene oxide (EO), propylene oxide (PO) or butylene oxide (BO) with: 1,1,1-tris[(2-hydroxyethoxy)methyl]ethane, 1,1,1-tris-[(2-hydroxypropoxy)methyl]propane, triethanolamine, triisopropanolamine, pyrogallol or phloroglucinol, in order to form a chain-extended polyol.

8. A method as claimed in claim 2 wherein said polyurethane pre-polymer comprises a mixture of between 10% and 90% of said isocyanate component and 10% to 90% polyol component.

9. A method as claimed in claim 2 wherein said resin system is an epoxy resin pre-polymer, which is a reaction product of epichlorohydrin and Bisphenol A, and an epoxy resin hardener.

10. A method as claimed in claim 9 wherein said epoxy resin hardener in said epoxy resin pre-polymer is an aliphatic, alicyclic, aromatic, imido, amide or amine containing material, and blends thereof.

11. A method as claimed in claim 10 wherein said resin system comprises an epoxy resin having an epoxide equivalent weight of between 140 and 650, and an amine hardener having an amine equivalent weight of between 15 and 400.

12. A method as claimed in claim 1 wherein said reinforcing materials are preferably in the form of organic or inorganic particles or fibers, and have a variety of densities, sizes, and regular and irregular shapes.

13. A method as claimed in claim 1 wherein said reinforcing materials have a bulk density of less than 0.32 g/cc and the ratio of pre-polymer resin to filler is between 0.1 and 5 to 1 on a volume basis.

14. A method as claimed in claim 13 wherein the ratio of pre-polymer resin to filler is between 0.2 and 3 to 1, on a volume basis.

15. A method as claimed in claim 1 wherein said reinforcing materials have a bulk density equal to or greater than 0.32 g/cc and the ratio of pre-polymer resin to filler is between 0.1 and 2.5 to 1 on a volume basis.

16. A method as claimed in claim 15 wherein the ratio of pre-polymer resin to filler is between 0.2 and 2 to 1, on a volume basis.

17. A method as claimed in claim 1 wherein said composite material has a density of between 0.032 grams/cc to 1.60 grams/cc.

18. A method as claimed in claim 1 additionally comprising additional additives selected from the group of catalysts, surfactants or blowing agents.

19. A method as claimed in claim 1 wherein said forming stage is conducted under heat and/or pressure, and is accomplished using:
1. an injection molding process;
2. an extrusion process;
3. a calendaring process;
4. a compression molding process;
5. a spray foam application process;
6. a slab stock foam process; or using
7. a rotational molding process.

20. A rigid, semi-rigid or flexible composite or foam composite material having a density of between 0.032 to 1.60 g/cm³ and which comprises a polyurethane or epoxy resin system, a high level of organic or inorganic filler, and optionally catalysts, surfactants or blowing agents,

21. A material as claimed in claim 20 wherein said resin system is a polyurethane resin system which comprises a polyurethane pre-polymer comprising an isocyante and a polyol.

22. A material as claimed in claim 21 wherein said isocyanate component is selected from the group consisting of toluene-2,4-diisocyanate, toluene-2,6-diisocyanate, commercial mixtures of toluene-2,4- and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 3,3′-diphenyl-4,4′-biphenylene diisocyanate, 4,4′-biphenylene diisocyanate, 3,3′-dichloro-4,4′-biphenylene diisocyanate, 1,6-hexamethylene diisocyanate, 1,4-tetramethylene diisocyanate, 1,10-decamethylene diisocyanate, 1,5-naphthalenediisocyanate, cumene-2,4-diisocyanate, 4-methoxy-1,3-phenylenediisocyanate, 4-chloro-1,3-phenylenediisocyanate, 4-bromo-1,3-phenylenediisocyanate, 4-ethoxy-1,3-phenylenediisocyanate, 2,4′-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediisocyanate, 9,10-anthracenediisocyanate, 4,4′-diisocyanatodibenzyl, 3,3′-dimethyl-4,4′-diisocyanatodiphenylmethane, 2,6-dimethyl-4,4-diisocyanatodiphenyl, 2,4-diisocyanatostilbene, 3,3′-dimethyl-4,4′-diisocyanatodiphenyl, 3,3′-dimethoxy-4,4′-diisocyanatodiphenyl, 4,4′-methylene bis(diphenylisocyanate), 4,4′-methylene bis(dicyclohexylisocyanate), isophorone diisocyanate, PAPI (Polymeric diphenylmethane diisocyanate), 1,4-anthracenediisocyanate, 2,5-fluorenediisocyanate, 1,8-naphthalenediisocyanate, and 2,6-diisocyanatobenzfuran.

23. A material as claimed in claim 21 wherein said polyol component is selected from the group consisting of glycerol, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5 and 1,2,6-hexanetriol, 1,1,1-trimethylolpropane, or is made by reacting ethylene oxide (EO), propylene oxide (PO) or butylene oxide (BO) with: 1,1,1-tris[(2-hydroxyethoxy)methyl]ethane, 1,1,1-tris-[(2-hydroxypropoxy)methyl]propane, triethanolamine, triisopropanolamine, pyrogallol or phloroglucinol, in order to form a chain-extended polyol.

24. A material as claimed in claim 21 wherein said polyurethane resin system comprises between 10 and 90% of said isocyanate component and 10% to 90% of said polyol component.

25. A material as claimed in claim 20 wherein said resin system is an epoxy resin system comprising an epoxy resin and a hardener, and wherein said epoxy resin has an epoxide equivalent weight of between 140 and 650, and said hardener is an amine hardener having an amine equivalent weight of between 15 and 400.

26. A rigid, semi-rigid or flexible foam composite material as claimed in claim 20 having a variable cross-sectional density so as to provide a natural “sandwich” type of material with a thick, higher density outer layer and a lower density inner core, and has a combination of microcellular thin wall sections, and open cell core sections.

27. A rigid, semi-rigid or flexible composite material, as claimed in claim 20 wherein said composite material is non-porous and has a uniform cross-sectional density.
